(19) United States
(12) Patent Application Publication
(10) Pub. No.: US 2014/0020288 A1
(43) Pub. Date: Jan. 23, 2014

(54) Root Ball Container

(71) Applicant: George Sikes, Brownwood, TX (US)

(72) Inventor: George Sikes, Brownwood, TX (US)

(21) Appl. No.: 13/795,202

(22) Filed: Mar. 12, 2013

Related U.S. Application Data
(63) Continuation-in-part of application No. 29/427,421, filed on Jul. 18, 2012, now Pat. No. D684023.

(51) Int. Cl. A01G 23/04

(52) U.S. Cl. CPC A01G 23/043
USPC 47/32.7

(57) ABSTRACT

An improved root ball container having a base member and a surrounding sidewall member forming a cavity therein for containing the root ball of a tree or other plant. The opening at the top of the sidewall member is smaller than the length or diameter of the base member, thereby providing stability to the plant during storage, growing and transport. The container may be moisture permeable or solid, and may consist of flexible or rigid sidewall and base members. The base may feature a platform member to further elevate the base member and root ball above the ground surface to prevent root damage during growing and/or storage of the tree or plant root ball enclosed by the root ball container.

### CROSS-REFERENCE TO RELATED APPLICATIONS

This application is a continuation-in-part of U.S. patent application Ser. No. 29/427,421, filed on Jul. 18, 2012.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The present invention relates to root ball containers for growing and storing trees and plants above ground and for transporting said trees and plants with minimal disruption to the root ball.

2. Description of Related Art Including Information Disclosed Under 37 CFR 1.97 and 1.98

During temporary storage, plants, and in particular trees, require substantial support for the root ball as well as the overall plant structure. In particular, wind load exerted on the tree canopy and tree trunk can cause a temporarily stored tree to tip over, fall to the ground and sustain damage. This can occur regardless of whether the tree is stored within a root ball container above ground or below. When stored above ground the container has only the weight of the root ball working with the width of the root ball base in contact with the ground surface to hold the tree upright and to act to resist tipping of the tree caused by wind shear. Without circumferential side stability (as provided by a buried container), the tree is relatively easy to tip. However, even belowground storage has its shortcomings. When stored below ground, the temporary container is buried within the soil up to approximately the top edge of the container, so that no extra soil is applied to the top of the root ball (which can cause the tree to essentially suffocate and die). Moreover, the oscillations of the plant canopy and stem work the buried container in a “back-and-forth” motion, which causes the soil surrounding the container to compact and lose its “grip” on the root ball. Thus, even a buried conventionally grown tree is subject to tipping, which may result in damage to the plant contained therein.

Conventional container-grown trees utilize what can essentially be described as a “bucket” in which the root ball is maintained until the tree is transplanted into the ground. Such containers typically have a flat bottom with sides that rise as a cylinder from the container bottom in a perpendicular fashion, or that expand outward in increasing diameter such that the top opening is wider than the container bottom (much like a typical “flower pot” shape). The flat bottom allows the container and tree to stand on a surface, while the sides provide support for the root ball to prevent the roots from spilling outward during transport. However, because the container bottom is usually the same size or even narrower than the container's top opening, such containers are rather top heavy and unstable. Even a rather light wind load on the tree canopy can cause such containers to tip over, damaging the tree and root ball.

Conventional containers are also typically constructed from a plastic material, and have smooth sides lacking perforations. These prior art containers effectively prevent the plant or tree roots from being air pruned, which may lead to root girdle, or spiraling roots. Although the surrounding ground soil will provide some vertical stability to the tree after planting, such containers are never buried entirely beneath the soil and a relatively light wind load on the canopy and resulting oscillations will cause the tree to tip and the root ball to easily pull away from the compacted soil. The use of perforated sides in a buried container allows for tree roots to penetrate and to grip the surrounding soil, but such containers are impractical since the root ball must be disturbed when removing the tree from this temporary location for transplantation in a desired location. Moreover, roots that penetrate the bottom of such containers and into the soil are exceedingly difficult to safely trim without digging beneath the root ball or uprooting the root ball and causing shock and damage to the root system.

There is a need in the art for a root ball container that provides improved stability for a contained tree or plant to prevent tipping due to wind loads, while in the growing process above ground or after the tree or plant is planted in to the ground. Further, there is a need for a root ball container that has improved stability to prevent tipping in below ground situations after planting as well as prior to planting. The present invention addresses these shortcomings as well as others, as will be demonstrated to one of ordinary skill after a thorough reading and understanding of the detailed description herein.

### BRIEF SUMMARY OF THE INVENTION

The present invention is directed to an apparatus comprising an improved root ball container for cultivating and growing trees and plants above ground and which acts to provide improved stability and tipping resistance due to wind shear load and other environmental forces. In one embodiment, the root ball container includes a base member and a surrounding sidewall member forming a cavity therein for containing the root ball of a tree or plant. The opening at the top of the sidewall member is smaller than the length or diameter of the base member, thereby providing stability to the plant during storage, growing and transport. The container may be moisture permeable or solid, and may consist of flexible or rigid sidewall and base members. The base may feature a platform member to further elevate the base member and root ball above the ground surface to prevent root damage during growing and/or storage of the tree or plant root ball enclosed by the root ball container. In one embodiment, the sidewall member and base member may be assembled for use and disassembled after use for ease of transport, storage and reuse.

In one embodiment, the present invention comprises a root ball container including a base member and an attached conical sidewall member with an opening at the top and bottom of the conical member wherein the diameter of the top opening of the conical sidewall member is smaller than the diameter of the bottom opening of the conical sidewall member and corresponding base member which is detachably secured to the bottom of the conical sidewall member. The larger diameter of the base member acts to increase the magnitude of the counter-moment force available to resist the rotational moment or torque created by wind shear loads acting on the tree canopy or plant and root ball contained within the root ball container. As a result, trees and plants with root balls secured in the disclosed root ball container are consistently maintained in a healthy upright growing position with the risk of tipping and/or associated damage to the tree or plant canopy, stem, or root system minimized, if not altogether prevented.

### BRIEF DESCRIPTION OF THE SEVERAL VIEWS OF THE DRAWING(S)

The present invention will be more fully understood by reference to the following detailed description of the preferred embodiments of the present invention when read in conjunction with the accompanying drawings, wherein:

FIG. 1 is a depiction of a first embodiment of the present invention encasing the root ball of a tree or plant;

FIG. 2 is a depiction of a cutaway view of an embodiment showing the root ball and tree planted in the soil after the root ball container has been removed;

FIG. 3 is a cutaway depiction of a portion of an embodiment highlighting the construction of the root ball container;

FIG. 4 is a perspective view of an embodiment of the present invention depicting a semi-rigid or rigid root ball container configuration;

FIG. 5 is an exploded view of an embodiment highlighting the modular nature of the root ball container; and

FIG. 6 is a perspective view of an additional embodiment of the present invention.

The above figures are provided for the purpose of illustration and description only, and are not intended to define the limits of the disclosed invention. Use of the same reference number in multiple figures is intended to designate the same or similar parts. Furthermore, when the terms “top,” “bottom,” “first,” “second,” “upper,” “lower,” “height,” “width,” “length,” “end,” “side,” “horizontal,” “vertical,” and similar terms are used herein, it should be understood that these terms have reference only to the structure shown in the drawing and are utilized only to facilitate describing the particular embodiment. The extension of the figures with respect to number, position, relationship, and dimensions of the parts to form the preferred embodiment will be explained or will be within the skill of the art after the following teachings of the present invention have been read and understood.

### DETAILED DESCRIPTION OF THE INVENTION

While the following description of the embodiments discusses primarily trees, the invention is equally useful and applicable for other container grown plants that produce a stem. One of ordinary skill in the art to which the invention pertains will appreciate this utility and will understand that the accompanying claims should not be limited to use with trees alone, but should instead be construed to cover other such plants.

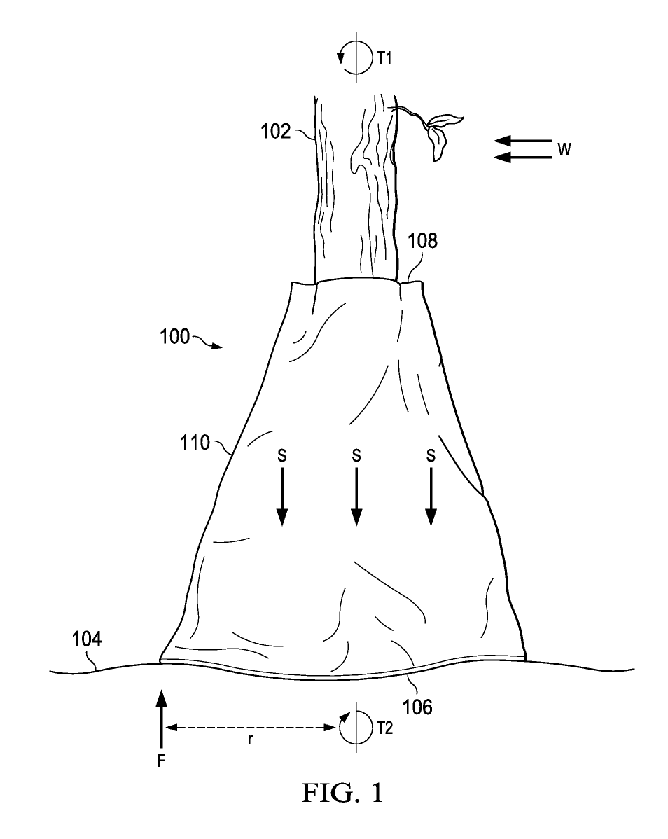

FIG. 1 depicts a first embodiment of the present invention as it encases the root ball of a tree. As shown, flexible container (100) surrounds the root ball of the tree or plant (102) as it sits upon the surface of the ground (104). The diameter of container base member (106) is larger than the diameter of the container top stem opening (108) and generally forms a conical shape about the root ball of the tree (102) with container sidewall (110). Dimensions for container base (106) and stem opening (108) are determined by the ultimate size of the desired container-grown plant, and may be readily ascertainable and so constructed by one of ordinary skill in the art. For example, a tree grown in a typical 5-gallon container may be 2 to 5 feet in height and have a trunk (stem) size of under 0.5 inches in diameter. For such a tree of this dimension, container base (106) might be between about 1 to 2 feet in diameter while stem opening (108) might be between about 1 to 6 inches in diameter. The height of container (100) is dimensioned to provide adequate dirt and root volume to sustain the growing tree (in this case, approximately 5 gallons). A tree grown in a typical 15-gallon container may be 6 to 12 feet in height and have a trunk size of between 0.5 and 1.0 inch in diameter. Thus, base member (106) and stem opening (108) diameters as well as the height of the container sidewall (110) between base member (106) and stem opening (108) would be dimensioned by the user accordingly.

The container (100) embodiment shown in FIG. 1 is made of a flexible material, such as heavy weight burlap, textile, landscape fabrics or similar durable fabric as known in the art. The depicted embodiment is flexible to allow it to collapse in an essentially flat form for ease in stacking or storage and when in use to easily form around and contain the root ball. In the embodiment shown, the container (100) is filled with soil from the top opening (108) to approximately mid-level and the immature tree root ball is set forth therein. Additional soil is added to the container (100) to fill the remaining void space in the container (100) to a level appropriate for the plant. Because the container is constructed of a breathable textile or fabric, such as burlap, it is moisture permeable and, therefore the contained soil and root ball may be watered by applying water to the sides of the container as well as along the plant stem (102). Burlap is a natural, biodegradable fabric that is ideal for use as a root ball container. However, one of ordinary skill will appreciate that other flexible moisture permeable materials, textiles, fabrics, both natural or man-made, may be utilized and are within the scope of the present invention.

The embodiment depicted in FIG. 1 is generally conical in shape, having a round base (106) attached to a conical sidewall member (110) that rises in decreasing diameter to top stem opening (108) through which the plant stem protrudes. When joined, the wall member (110) forms an acute angle with respect to the base member (106) and an inner volume is created therein to accept the root ball. Sidewall member (110) may be formed from a single piece of fabric or textile, such as burlap, with a joined and finished seam that creates the conical section as further shown in FIG. 3 hereafter. In another embodiment, the seam is not finished but instead uses a releasable attachment means such as a zipper, hook and loop fasteners, snaps, buttons or the like.

For purposes of general background, moment or torque is the term generally used to describe the tendency of a force applied to a rigid or semi-rigid body causing the body to rotate, turn, or twist a about an actual or assumed pivot point. An object experiences a moment or torque whenever a force is applied to it. Moments or torques have primary dimensions of length multiplied by the applied force, expressed in mathematical terms as M=d×F, where M is the moment or torque, d is the distance between the applied force and pivot point or assumed pivot point, and F is the applied force magnitude. As previously discussed herein and depicted in FIG. 1, when trees are grown above ground under typical nursery or tree farm conditions using typical prior art root ball containers, wind shear loads (W) acting on the tree canopy and tree trunk or stem (102) act to create a rotational torque or moment (T1) which imparts a variable force on the tree and root ball acting to tip or push the tree over and on to the ground. When this occurs, the tree canopy, tree and root ball usually suffer damage from shock and exposure. If the tree or plant remains in this position for a period of time, it becomes increasingly susceptible to withering, disease, pests and eventual death. Typical prior art root ball containers, similar to a “flower pot” shape, generally utilize a larger diameter tree stem opening relative to a smaller diameter container base member which results in an “inverted cone” configuration with the smaller surface area of the cone in contact with the ground. This smaller surface area in contact with the ground results in reducing the counter-rotational moment force which acts to resist the rotational moment force created by the wind load (W) acting on the tree canopy and tree stem since the radial dimension of the base container (r) is smaller than the radial dimension of the top stem opening resulting in a smaller torque resistance force per the mathematical relationship described above. Likewise, the prior art container containing the root ball soil mass contained within the container is distributed over a smaller surface area which reduces the available compressive resistance force available to resist wind shear load and tipping moment acting on the tree canopy and tree stem.

In an embodiment disclosed herein, container (100) is designed to overcome the shortcomings of prior art containers described above. As shown in FIG. 1, the inventive embodiment shown discloses container (100) with a larger diameter base (106) relative to the smaller diameter tree stem opening (108). Wind shear load (W) imparts a force on the tree canopy and tree stem and produces a tipping moment (T1) that acts to push or tip the tree over. In this configuration, the larger diameter base (106) which is resting on the ground (104) acts to respond with an increased counter-tipping moment force (T2) which is magnified due to the larger radial distance (r) extending from the approximate pivot point or center of the root ball contained within container (100) to the periphery of root ball container (100) and extending in all radial directions as per the mathematical relationship described above. Likewise, the resistive compressive force of the ground (104) soil and compressive force generated by the distributed tree canopy, tree stem and root ball soil weight load (S) existing within, around and out to the peripheral circumference of the container (100) assist in countering the wind shear load (W) and associated tipping or rotational moment (T1) forces thereby minimizing and/or preventing the tipping and rocking of trees and plants with root balls in container (100) due to the effects of wind shear. An additional benefit of the conical design of container (100) includes the ability to resist wind shear load (W) and tipping moment force (T1) that may act upon the tree canopy or tree stem from any vertical or horizontal direction.

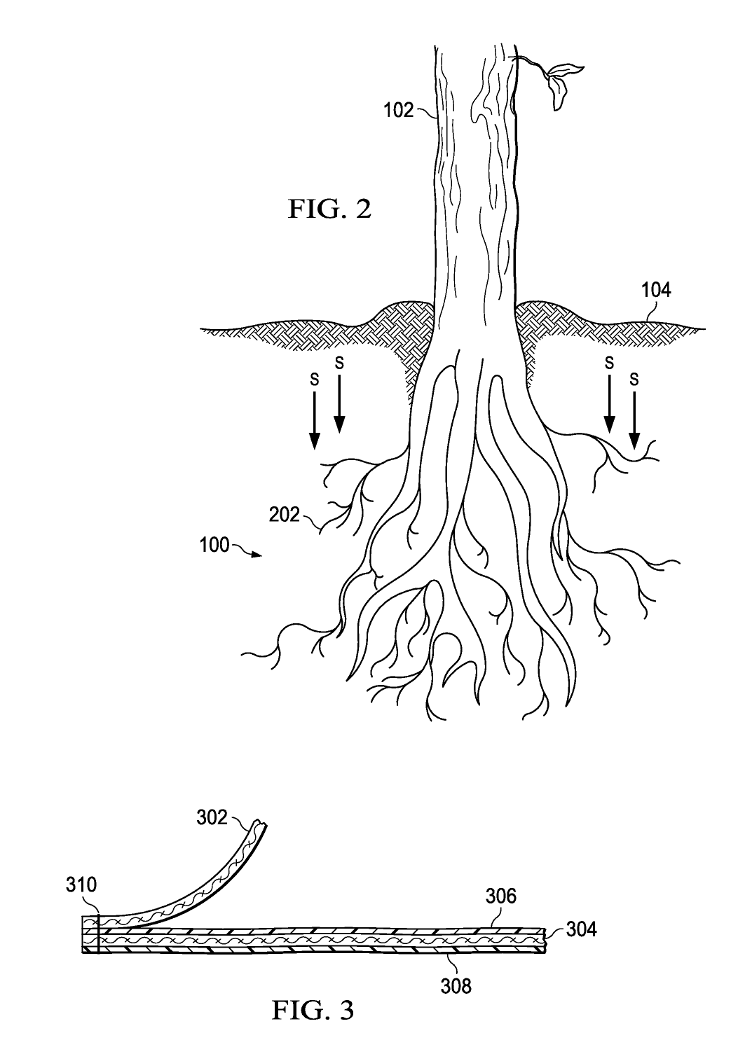

FIG. 2 depicts a cutaway view of an embodiment wherein the container (100) has been removed and the root ball of a tree or plant is implanted in the soil. A hole in the ground must be prepared that is at least as wide as the base (106) diameter, but is slightly shallower than the height from the base (106) to the top opening (108) (see FIG. 1). Once the hole is prepared, the tree is removed from the container (100), inserted into the ground (104) and soil is backfilled in the hole around the root ball. Once the remainder of the hole is filled, the weight of tree canopy, tree, root ball and the surrounding soil acts on the acutely angled sides of the conically shaped root ball which had been removed from container (100) to produce a compressive downward force (S) that provides additional stability to the root ball and plant allowing the roots (202) to take hold and secure the tree or plant in the surrounding soil 104). Force (S) aids in stabilizing the newly planted tree or plant by providing a resistive counterweight force to counter the effects of tipping moment and wind shear load on the tree (as shown in FIG. 1) which may be applied from any direction in the horizontal and vertical planes relative to the tree canopy and tree stem (102).

FIG. 3 provides a cutaway depiction of a portion of the container embodiment described in FIG. 1 highlighting the construction of the seam formed by the junction of the container base with the container sidewalls. As shown, container sidewall member (302) comprises a single layer of textile or fabric, such as burlap or other landscape fabric. Container base member (304) comprises a single layer of textile or fabric, such as burlap or other landscape fabric as known in the art. An optional additional layer of polymer, plastic, textile or metal-coated material forming barrier layer (306) is also shown. Barrier layer (306) prevents penetration of the roots at the container base member (304) and aids in directing the roots to grow toward the conical sidewall (302) of the root ball container. This is so because while it is relatively easy to sever or prune the roots at the container walls in the above ground storage condition, it is extremely difficult, if not possible, to sever or prune roots that may exist beneath the container and which have grown into the ground upon which the container is resting. A secondary barrier layer (308) of polymer, plastic, textile or metal coated material may also be secured to the outer surface of the container base member (304) to provide for wear resistance during above ground storage and transport. One of ordinary skill will appreciate that barrier layers (306, 308) are optional, meaning that other embodiments of the container may utilize any combination of the layers as described. A seam cap (310) joins the sidewall member (302) and base member (304) materials to prevent separation. One of ordinary skill in the art will appreciate that such seam caps and seams may be formed by any conventional means, including but not limited to stitching, welding, gluing, stapling, crimping, or the like as is known in the art.

In yet another embodiment, base member (304) and sidewall member (302) may be constructed from different materials. For example, sidewall member (302) may be constructed of flexible fabric or textiles as discussed herein, while base member (304) comprises a rigid or flexible plastic, textile, polymer or metal. Such a configuration will still allow sidewall member (302) to collapse upon base member (304) for storage yet can readily extend to create the internal volume for containment of the root ball during use. A metal base member (304) may utilize a barrier layer or multiple coated layers (306, 308) for corrosion prevention or abrasion protection as well. Another use for a metal or metallized base member (304) material is to add weight to the overall structure, which will aid in maintaining the contained plant upright during above ground storage. A seam cap (310) joins the sidewall wall (302) material with the base (304) material. In another embodiment sidewall member (302) and base member (304) are both formed from rigid materials as described later herein. Again, one of ordinary skill in the art will appreciate that such seams may be formed by any conventional means, including but not limited to stitching, welding, gluing, stapling, crimping, or the like.

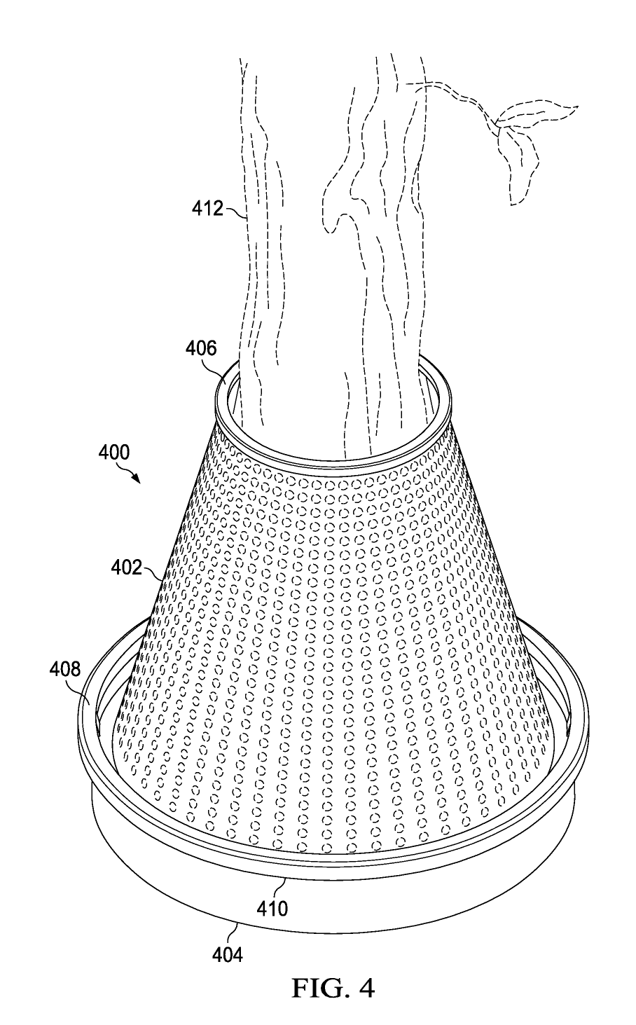

FIG. 4 depicts a perspective view of another embodiment of the present invention, emphasizing alternative construction materials and an alternative root ball container configuration. As shown, container (400) is comprised of a conical wall member (402) having a plurality of perforations for moisture permeability and a circular base member (404). The perforations in wall member (402) also serve to aid in root pruning. The conical wall member (402) may be constructed of rigid or semi-rigid plastic, metal, wood, or polymer material, and is formed in a single, seamless or seamed piece as desired. For added rigidity and to assist in handling, a top lip (406) is also formed, defining the top opening through which a contained plant stem (412) may extend. The base (404) is formed from the same or similar material, and includes a base locking-ridge (410) that engages the wall locking-ridge (408) formed in the lower portion of the wall member (402). When engaged, wall member (402) walls form an acute angle with respect to base member (404). The wall member (402) and base member (404) in this embodiment may be detached for storage (the wall members and base members are stackable) and assembled for reuse when the need arises. In one embodiment, the wall member (402) thickness is such that a sharp knife or box razor may penetrate to create a split sufficient to remove the container from around the root ball without excessive disturbance to the root ball. In one embodiment, the wall member (402) includes a defined seam extending between base member (402) and top lip (406) that may be opened or closed at will, or which may incorporate hook and loop fasteners, zippers, snaps, buttons, hooks or other fastening means as known in the art, which allows for removal of container (400) from around the root ball without cutting the container or requiring tools to open, close or separate the container (400) components. In yet another embodiment, the wall member (402) includes a perforated seam extending between base member (402) and top lip (406) that allows tearing of such seam by hand to facilitate removal of the container (400) from the root ball.

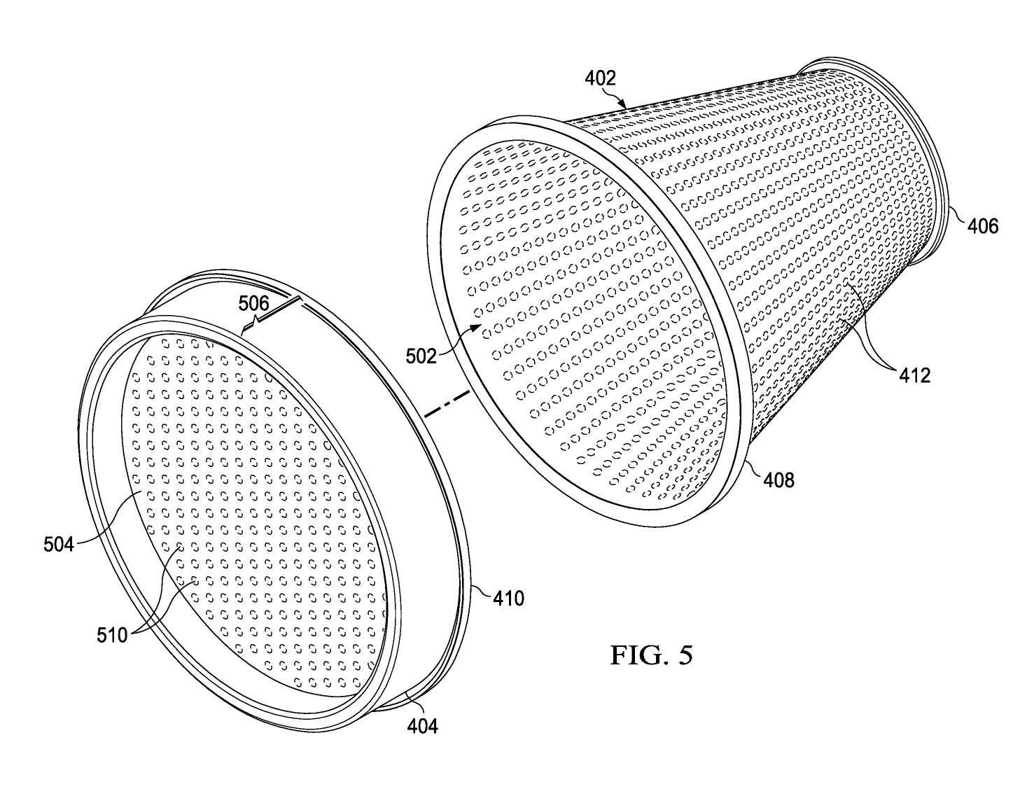

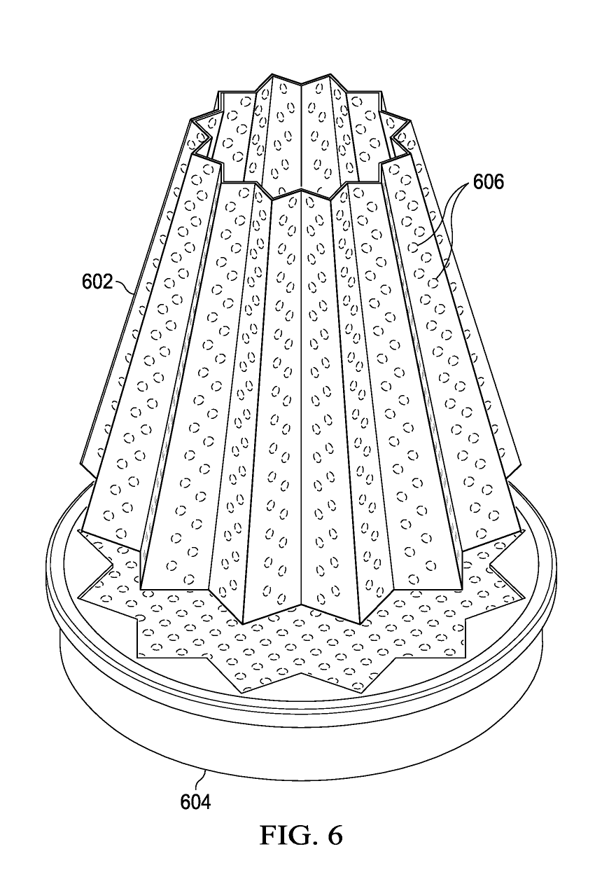

FIG. 5 provides an exploded view of one embodiment highlighting the modular nature of the root ball container. As depicted, conical wall member (402) has an inner volume (502) for containing the root ball of a plant or tree and includes perforations (412) through which moisture may pass, which allows the root ball to breathe and provides easy access for root pruning without requiring removal of any component of the container (400) from the root ball. The base member (404) includes a plurality of perforations (510) through which moisture may pass, which allows the root ball to breathe, provides easy access for root pruning, and prevents water buildup that can cause the roots to rot and degrade. The base member (404) also comprises a cylindrical platform member with a circumferential sidewall (506) that raises the base member platform surface (504) such that the plant root ball does not touch the ground surface during above ground use. As described earlier herein, when the root ball is removed from container (400) and buried in the ground, the acute root ball angle shape formed by the wall member (402) around the root ball periphery while the root ball is contained within container (400) takes advantage of the weight of the backfilled soil resting on top of the buried root ball which provides added stability and counter-moment resistance to minimize and/or prevent tipping or rocking of the tree or plant due to wind shear loads.

Although a conical shape is described in the disclosed embodiments, other embodiments of the invention may utilize other geometric shapes and forms. For example, FIG. 6 presents an exploded perspective view of an embodiment of the present invention wherein the container wall member (602) is constructed of rigid or semi-rigid material with vertical pleats. The pleated wall member (602) interlocks with the rigid or semi-rigid base member (604) to create the container volume for supporting a plant root ball therein. Such a pleated design acts to deflect and direct plant or tree root ball roots to grow to and through the perforations in the pleated wall section (602) to aid in root pruning. The pleated wall member (602) may be formed as a single piece of material, or may be created from a single or multiple sheets or pieces of material with an edge or seam that is joined, temporarily or permanently, by a commonly understood fastening means, such as hook and loop material, buttons, zippers, hooks, and other means as known in the art to form the depicted shape. Perforations (606) in wall member (602) and base member (604) provide moisture permeability to the root ball and aid in root pruning. Other shapes are also possible and are within the scope of the present invention. For example, another contemplated embodiment of the invention may use a triangular base to create a triangular base pyramid shape having an opening near the top (vertex) for a plant stem. Another contemplated embodiment utilizes a square base to create a square base pyramid having an opening near the top (vertex) for a plant stem. Other similar shapes are envisioned and are within the scope of the claims.

The invention may be embodied in other specific forms without departing from the spirit or essential characteristics thereof. The present embodiments are therefore to be considered in all respects as illustrative and not restrictive. Accordingly, the scope of the invention is established by the appended claims rather than by the foregoing description. While various alterations and permutations of the invention are possible, the invention is to be limited only by the following claims and equivalents.

I claim:

1. A root ball container, the container comprising:
a base member and an attached sidewall member forming an acute angle with the base, the sidewall member including an opening at the top having a diameter smaller than the diameter of the base member, the interior of the attached base and wall members dimensioned to contain the root ball of a plant.

2. The root ball container of claim 1, wherein the base member is substantially circular and the sidewall member is substantially conical.

3. The root ball container of claim 1, the base member further comprising:
a barrier layer, wherein the barrier layer prevents the penetration of the plant roots through the base member.

4. The root ball container of claim 1, the base member further comprising:
at least two barrier layers, the base member sandwiched therebetween, wherein a first barrier layer prevents the penetration of the plant roots outside of the container and the second barrier layer protects the base member material from external corrosion.

5. The root ball container of claim 1, wherein the base member and the sidewall member are constructed of moisture permeable fabric.

6. The root ball container of claim 1, wherein the base member and the sidewall member are constructed of plastic or metal.

7. The root ball container of claim 1, wherein the base member is constructed of plastic or metal and the sidewall member is constructed of fabric, the base member weight providing additional vertical stability for the plant contained therein.

8. The root ball container of claim 1, wherein the sidewall member is securably detachable from the base member to allow stacking, storage and reuse of the container parts.

9. The root ball container of claim 1, wherein the sidewall member is detachable from the base member, the sidewall member further comprising a seam to allow for removal of the sidewall member from the plant stem.

10. The root ball container of claim 1 wherein the sidewall member further comprises a plurality of perforations dimensioned so that moisture may pass through the perforations.

11. The root ball container of claim 1, wherein the sidewall member further comprises a plurality of pleats, wherein the pleats provide additional stability for the container.

12. The root ball container of claim 1, the base member further comprising a cylindrical platform member having an open interior wherein the platform member provides support for the base member to substantially prevent contact of the base member with the ground beneath.

13. A root ball container, the container comprising:
a substantially circular base member and an attached substantially conical sidewall member forming an acute angle with the base member, the sidewall member including an opening at the top having a diameter less than the diameter of the base member, the interior of the attached base member and sidewall members dimensioned to contain the root ball of a plant.

14. The root ball container of claim 13, the base member further comprising:
a first barrier layer, wherein the first barrier layer prevents the penetration of the plant roots through the base member.

15. The root ball container of claim 13, the base member further comprising:
at least two barrier layers, the base member disposed between the first and second barrier layers wherein the first barrier layer substantially prevents the penetration of the plant roots through the base member and the second barrier layer substantially protects the base member material from external corrosion.

16. The root ball container of claim 13, wherein the base member and the sidewall member are constructed of moisture permeable fabric.

17. The root ball container of claim 13, wherein the base member and the sidewall member are constructed of a rigid material.

18. The root ball container of claim 13, wherein the base member is weighted to provide additional vertical stability for the plant contained therein.

19. The root ball container of claim 13, wherein the sidewall member is plastic or metal, the sidewall member further comprising a plurality of pleats, wherein the pleats provide additional stability for the container and plant contained therein.

20. The root ball container of claim 13, the base member further comprising a cylindrical platform member having an open interior, the platform member providing support for the base member to prevent contact of the base member with the ground.
